(19) United States
(12) Patent Application Publication
(10) Pub. No.: US 2003/0066367 A1
(43) Pub. Date: Apr. 10, 2003

(54) Guiding device for a positional adjustment having a lead-screw

(76) Inventor: Ming-Pang Liao, Taichung Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/974,425

(22) Filed: Oct. 9, 2001

(51) Int. Cl. F16H 25/20

(52) U.S. Cl. 74/89.36; 74/89.23

(57) ABSTRACT

A guiding device for positional adjustment having a lead-screw is composed of a controlling device and a carriage rest receiving the controlling device inside. The controlling device contains a pressing post and a resilient element to push the pressing post to adjust the relative distance between the carriage rest and the lead-screw so that the lead-screw is kept straight and the positional adjustment move in an exactly horizontal. Thus, calibrations of calibrating tools mounting on the positional adjustment are precise.

### BACKGROUND OF THE INVENTION

1. Field of the Invention

The present invention relates to a guiding device, and more particularly a guiding device for a positional adjustment having a lead-screw, that the guiding device keeps the positional adjustment moving in an exactly horizontal.

2. Description of Related Art

With reference to FIG. 5, a conventional positional adjustment for calibrating tools is composed of a casing (50) and a measuring carriage (60) movably mounted on the casing (50), wherein the measuring carriage (60) has a measure device (62) secured on a front face thereof to calibrate a tool (70).

The casing (50) of the conventional positional adjustment has a lead-screw (52) and a linear track (54) both laterally secured inside the casing (50). The lead-screw (52) is rotatably and can drives the measuring carriage (60) move on the linear track (54). A rotating plate (522) is immovably secured on one end of the lead-screw (52), in which an end protruding out from the casing (50). A track base (56) secured under the measuring carriage (30) is movably mounted on the linear track (54) of the casing (50). Therefore, when the rotating plate (522) rotates, the lead-screw (52) drives the measuring carriage (60) move laterally along the linear track (54) of the casing (50) to calibrate the tool (70).

However, the lead-screw (52) become curved after some time because the weight of the measuring carriage (60) imposes on the lead-screw (52). With reference to FIG. 6, the lead-screw (52) is no longer straight that makes the measuring carriage (60) mounted thereon inclined and not move in an exactly horizontal and not calibrating the tool (70) precisely.

Therefore, the present invention has arisen to mitigate and/or obviate the disadvantages of the conventional positional adjustment for calibrating tools.

### SUMMARY OF THE INVENTION

The main objective of the present invention is to provide a guiding device for a positional adjustment having a lead-screw that keeps the positional adjustment moving in an exactly horizontal during use.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a guiding device for a positional adjustment having a lead-screw in accordance with the present invention;

FIG. 2 is a top plan view of part of the guiding device for a positional adjustment having a lead-screw in accordance with FIG. 1;

FIG. 3 is a side cross-sectional view of the guiding device for a positional adjustment having a lead-screw that the guiding device is mounted on a lead-screw;

FIG. 4 is a partially enlarged cross-sectional view of the guiding device for a positional adjustment having a lead-screw in accordance with FIG. 3;

FIG. 5 is a perspective view of a conventional positional adjustment for calibrating tools; and

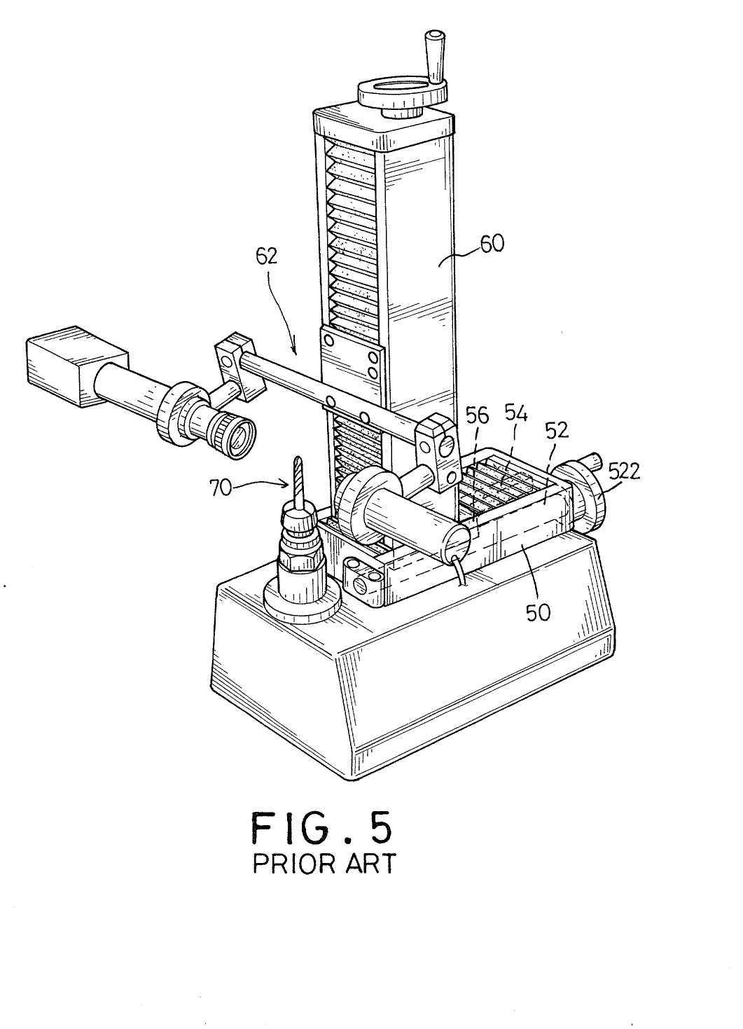

FIG. 6 is a side cross-sectional view of the conventional positional adjustment for calibrating tools that a lead-screw is curved after use for some time.

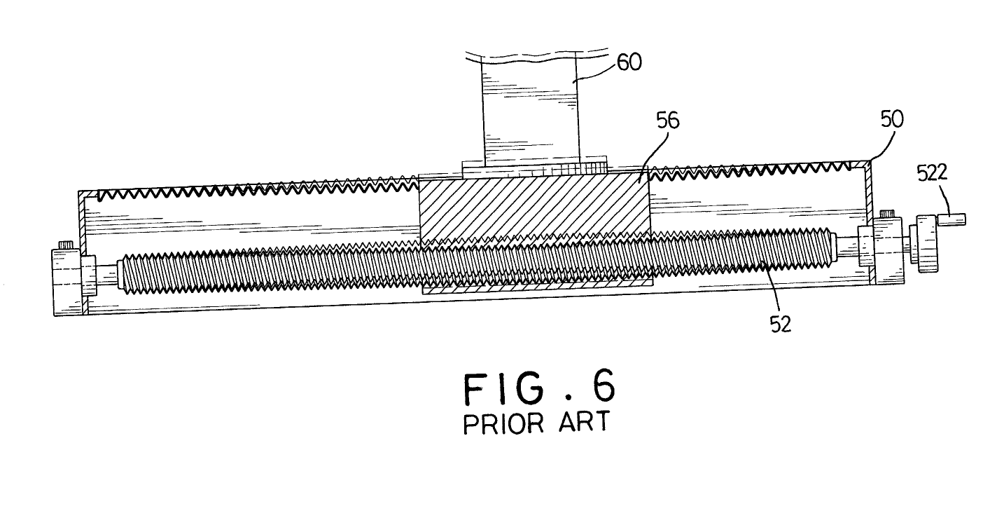

### DETAILED DESCRIPTION OF THE INVENTION

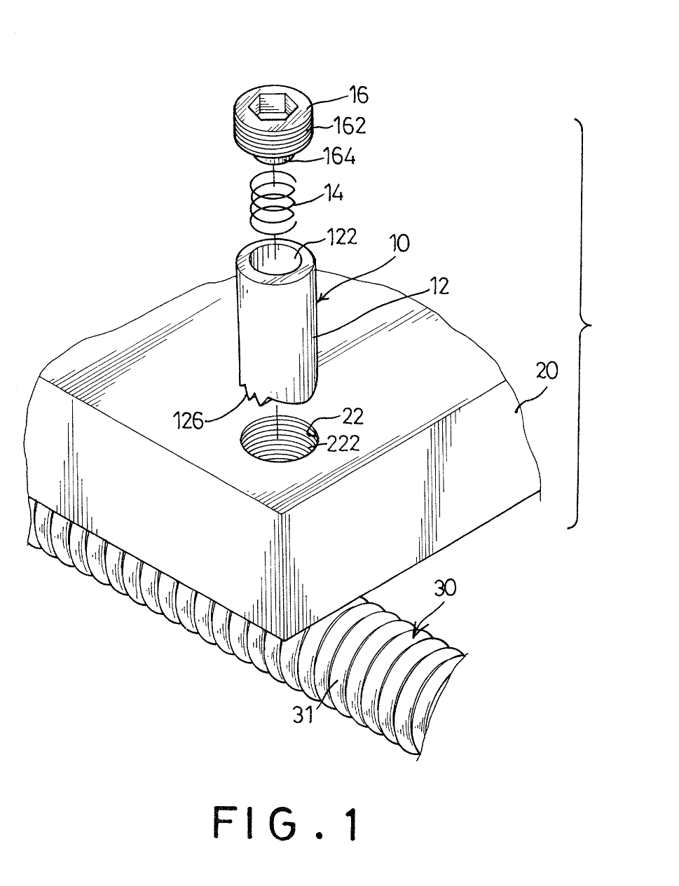

With reference to FIGS. 1, 2 and 3, a guiding device for a positional adjustment having a lead-screw, the guiding device is composed of a controlling device (10) and a carriage rest (20) receiving the controlling device (10) inside.

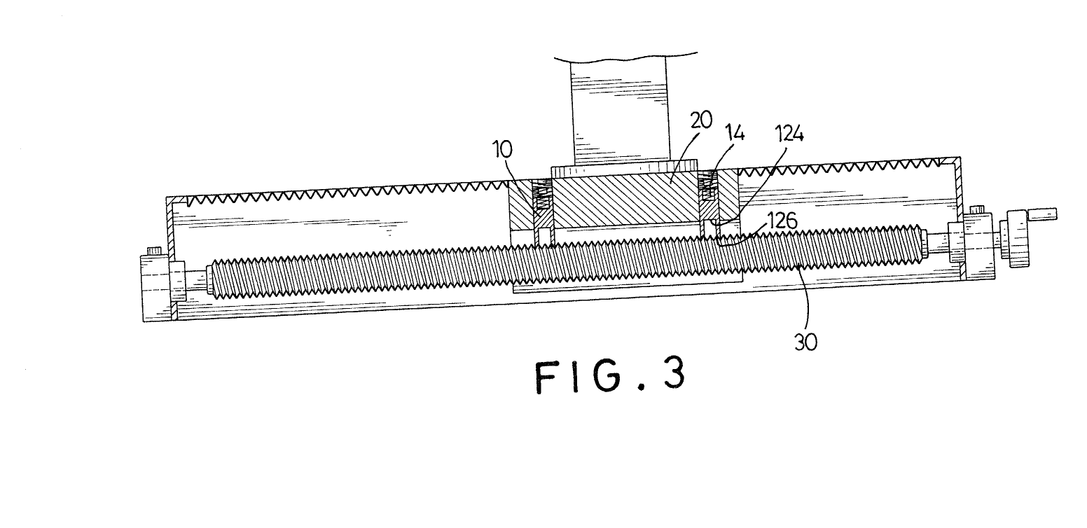

The controlling device (10) is composed of a pressing post (12), a resilient element such as a spring (14), and a bolt (16). The pressing post (12) has a recess (122) defined in an upper portion thereof to receive the spring (14) inside the recess (122), and a trench (124) defined in a bottom portion of the pressing post (12) to reduce the net weight of the pressing post (12). Two teeth (126) are formed on a distal end of the bottom portion of the pressing post (12) and adapted to mate with a thread (31) of the lead-screw (30, see FIG. 3) of the positional adjustment. A bolt (16) has a threaded surface (162) defined in periphery and a protrusion (164) extending downwardly and inserting into the center of the spring (14) so as to fix the spring (14).

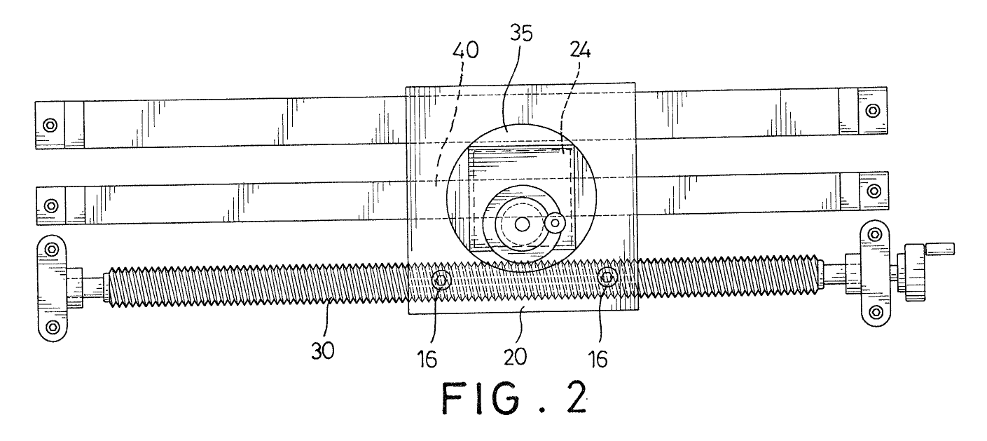

The carriage rest (20) is a cube and has a track base (24) adapted to be secured under a measuring carriage (35) and mounted on a linear track (40) of the adjustment so that the carriage rest (20) is able to slide along the linear track (40) (see FIG. 2). The carriage rest (20) has at least one through hole (22) vertically defined in the carriage rest (20) and the at least one through hole (22) each receives one controlling device (10) inside the through hole (22). An inner thread (222) is defined in an inner surface of the through hole (22) to mate with the threaded surface (162) of the bolt (16) so as to keep the pressing post (12) and the spring (14) inside the through hole (22). The spring (14) is compressed when the bolt (16) screws in the through hole (22) so as to provide a resilient force between the lead-screw (30) and the carriage rest (20). Therefore, the compressing post (12) is pushed and vertically moves inside the through hole (22) and keeps touch to the lead-screw (30).

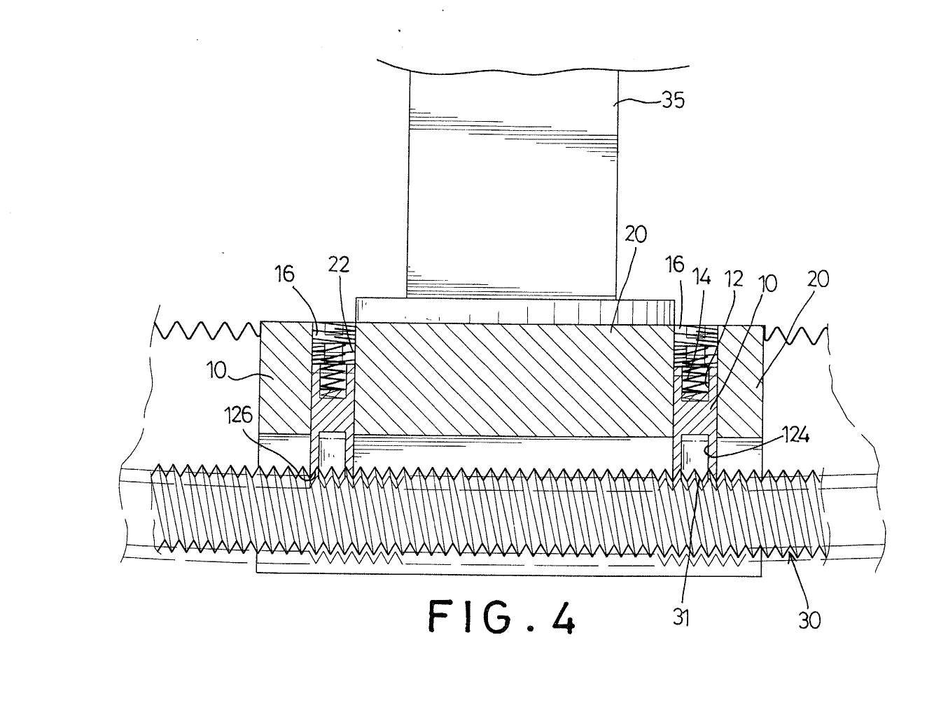

Now referring to FIG. 4, when the lead-screw rotates, the teeth (126) of the pressing post (12) move along the thread (31) of the lead-screw (30) to make the carriage rest (20) and the measuring carriage (35) slide on the linear track (40). At the same time, the spring (14) inside the recess (122) of the pressing post (12) mechanically and spontaneously adjust the relative distance between the carriage rest (20) and the lead-screw (30) by the resilient force of the spring (14) during any rotating time even the lead-screw (30) is curved. Thus, deformation of the lead-screw (30) and slant of the carriage rest (20) are avoided, the lead-screw (30) is not easily curved and the measuring carriage (35) mounted on the carriage rest (20) and the measuring carriage (35) moves in an exactly horizontal to provide an precisely measurement for tools.

Although the invention has been explained in relation to its preferred embodiments, it is to be understood that many other possible modifications and variations can be made without departing from the spirit and scope of the invention as hereinafter claimed.

What is claimed is:

1. A guiding device for a positional adjustment having a lead-screw, and the guiding device comprising:
a carriage rest adapted to be movably mounted a linear track of the adjustment, the carriage rest having at least one through hole defined therein; and
a controlling device received inside each at least one through hole of the carriage rest and adapted to be mounted on the lead-screw of the adjustment, each controlling device comprising:
a pressing post having at least one tooth formed on a bottom portion thereof, wherein the at least one tooth is adapted to mate with a thread of the lead-screw of the adjustment;
a resilient element mounted on the pressing post and abutting the pressing post; and
a bolt mounted on the carriage rest and compressing the resilient element;
wherein the resilient element is compressed to make the pressing post to vertically move in each at least one trough hole of the carriage rest to keep the pressing post mating with the lead-screw, therefore, the resilient element provides a resilient force to spontaneously adjust a relative distance between the carriage rest and the lead-screw so that positional adjustment is moved in an exactly horizontal movement.

2. The guiding device for positional adjustment having a lead-screw as claimed in claim 1, in which a recess is defined in an upper portion of each pressing post to receive the resilient element inside.

3. The guiding device for positional adjustment having a lead-screw as claimed in claim 1, wherein the pressing post further has a trench defined in the bottom portion thereof to reduce net weight of the pressing post.

4. The guiding device for positional adjustment having a lead-screw as claimed in claim 2, wherein the pressing post further has a trench defined in the bottom portion thereof to reduce net weight of the pressing post.

5. The guiding device for positional adjustment having a lead-screw as claimed in claim 1, wherein the resilient element is a spring.

6. The guiding device for positional adjustment having a lead-screw as claimed in claim 2, wherein the resilient element is a spring.

7. The guiding device for positional adjustment having a lead-screw as claimed in claim 3, wherein the resilient element is a spring.

8. The guiding device for positional adjustment having a lead-screw as claimed in claim 1, in which an inner thread is defined in an inner surface of the through hole of the carriage rest, and a threaded surface is defined in the bolt to mate with the inner thread of the through hole to keep the pressing post and the resilient element inside the through hole.

9. The guiding device for positional adjustment having a lead-screw as claimed in claim 2, in which an inner thread is defined in an inner surface of the through hole of the carriage rest, and a threaded surface is defined in the bolt to mate with the inner thread of the through hole to keep the pressing post and the resilient element inside the through hole.

10. The guiding device for positional adjustment having a lead-screw as claimed in claim 3, in which an inner thread is defined in an inner surface of the through hole of the carriage rest, and a threaded surface is defined in the bolt to mate with the inner thread of the through hole to keep the pressing post and the resilient element inside the through hole.

11. The guiding device for positional adjustment having a lead-screw as claimed in claim 5, in which an inner thread is defined in an inner surface of the through hole of the carriage rest, and a threaded surface is defined in the bolt to mate with the inner thread of the through hole to keep the pressing post and the resilient element inside the through hole.
